(19) United States
(12) Patent Application Publication
(10) Pub. No.: US 2009/0071314 A1
(43) Pub. Date: Mar. 19, 2009

(54) STRINGED INSTRUMENT FINGERING GUIDE

(76) Inventor: David A. Huwaldt, Arroyo Grande, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(21) Appl. No.: 12/236,291

(22) Filed: Sep. 23, 2008

Related U.S. Application Data
(63) Continuation-in-part of application No. 10/939,060, filed on Sep. 9, 2004, now Pat. No. 7,427,704.

(51) Int. Cl. G10D 3/06; G09B 15/00

(52) U.S. Cl. 84/314 R; 84/485 R

(57) ABSTRACT

An apparatus for a stringed instrument includes a replacement finger board for non-intrusive placement over an existing finger board that includes a plate having a top end and a bottom end. The plate has a varying thickness along the longitudinal length of a main axis connecting the top end and the bottom end, the thickness decreasing lengthwise from a first thickness at the first end of the plate to a second thickness at a second end of the plate.

### CROSS-REFERENCE TO RELATED APPLICATION

The present application is a continuation-in-part of U.S. application Ser. No. 10/939,060 having attorney docket No. 3263.002 (81242), and entitled “Stringed Instrument Fingering Guide” the contents of which are incorporated herein by reference in their entirety.

### BACKGROUND

The present invention relates generally to stringed instruments. Even more specifically, the present invention relates to an apparatus to aid in the playing of a stringed instrument.

Learning aids for stringed instruments have been designed, however, they have problems with their effectiveness, cost, portability and diversity. One solution places a first group of visual indicators mounted on the neck of a fret board, where each indicator is immediately beneath and in registry with a particular string and fret of the instrument so as to identify therewith. This design has a great drawback as the instrument will generally be more expensive than many very high end guitars. A person just learning to play the guitar will generally not want to make such a large investment.

Another solution comprises a sheet of autogenously adhesive plastic, such as cling vinyl, with a thin stiff backing board, within which is a set of dynamically operated markers such as LED lamps. The flexible nature of the backing board can easily cause the LEDs to fail. Additionally, the cling vinyl can become easily tangled rendering the aid unusable or stretch causing the indicator position to be incorrect.

Thus, a learning aid which overcomes these and other problems and disadvantages is needed.

### SUMMARY OF THE INVENTION

The present invention advantageously addresses the needs above as well as other needs by providing a learning aid for a stringed instrument.

In one example, an apparatus for a stringed instrument includes a replacement finger board for non-intrusive placement over an existing finger board that includes a plate having a top end and a bottom end. The plate has a varying thickness along the longitudinal length of a main axis connecting the top end and the bottom end, the thickness decreasing lengthwise from a first thickness at the first end of the plate to a second thickness at a second end of the plate.

In other examples, a learning apparatus for a stringed instrument includes a replacement finger board that is arranged to non-intrusively rest between an existing finger board and a plurality of strings of the stringed instrument. The finger board has a top end and a bottom end and has a varying thickness along the longitudinal length of a main axis connecting the top end and the bottom end. The thickness decreases lengthwise from a first thickness at the first end of the finger board to a second thickness at the second end of the finger board. The learning apparatus also includes controller configured to control an indicator coupled to the replacement finger board. The indicator displays information indicating which of the plurality of strings of the stringed instrument is to be played

In still other examples, a learning apparatus for a stringed instrument includes a replacement finger board arranged to non-intrusively rest between an existing finger board and a plurality of strings of the stringed instrument. The learning apparatus also includes a controller that is configured to control a display integral with the replacement finger board. The display presents information indicating which of the plurality of strings of the stringed instrument is to be played.

### BRIEF DESCRIPTION OF THE DRAWINGS

The above and other aspects, features and advantages of the present invention will be more apparent from the following more particular description thereof, presented in conjunction with the following drawings wherein:

FIG. 1 is an isometric diagram illustrating a learning aid in accordance with an embodiment;

FIG. 2 is an isometric diagram illustrating a learning aid of FIG. 1 detached from a stringed instrument and in accordance with an embodiment;

FIG. 3 is an isometric diagram illustrating the learning aid of FIG. 1 attached to a stringed instrument in accordance with one embodiment;

FIG. 4 is an isometric diagram illustrating a portion of the learning aid of FIG. 1 in accordance with an embodiment;

FIG. 5 is an isometric diagram illustrating a portion of the learning aid of FIG. 1 and a portion of a stringed instrument in accordance with an embodiment;

FIG. 6 is an isometric diagram illustrating an exploded portion of the learning aid of FIG. 1 in accordance with an embodiment;

FIG. 7 is an isometric diagram illustrating a portion of a learning aid in accordance with another embodiment;

FIG. 8 is a side cross sectional view illustrating a portion of the learning aid of FIG. 7 in accordance with an embodiment;

FIG. 9 is an isometric diagram illustrating a learning aid in accordance with an alternative embodiment;

FIG. 10 is an isometric diagram illustrating a learning aid in accordance with yet another alternative embodiment;

FIG. 11 is a top cross sectional view of a portion of the learning aid of FIG. 10 in accordance with an embodiment;

FIG. 12 is an isometric diagram illustrating a replacement bridge on a stringed instrument in accordance with an embodiment;

FIG. 13 is an isometric diagram illustrating another replacement bridge on a stringed instrument in accordance with an alternative embodiment;

FIG. 14 is an isometric diagram illustrating slightly elevated view of a learning aid in accordance with another embodiment;

FIG. 15 is an isometric diagram illustrating a bottom view of the learning aid of FIG. 14;

FIG. 16 is an isometric diagram illustrating an alternative embodiment of a learning aid in accordance with one embodiment;

FIG. 17 is an isometric diagram illustrating a slightly lowered view of a portion of a learning aid in accordance with an alternative embodiment;

FIG. 18 is a side cross sectional view of the learning aid of FIG. 17;

FIG. 19 is an isometric diagram showing an alternative example of a learning aid with displays;

FIG. 20 is a diagram showing the use of multiple displays on a stringed instrument;

FIG. 21 is a diagram of another diagram of using multiple displays on a stringed instrument.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims.

In many of the examples described herein, the use of a fret board is described. However, it will be appreciated that any type of finger board may be used including or not including frets.

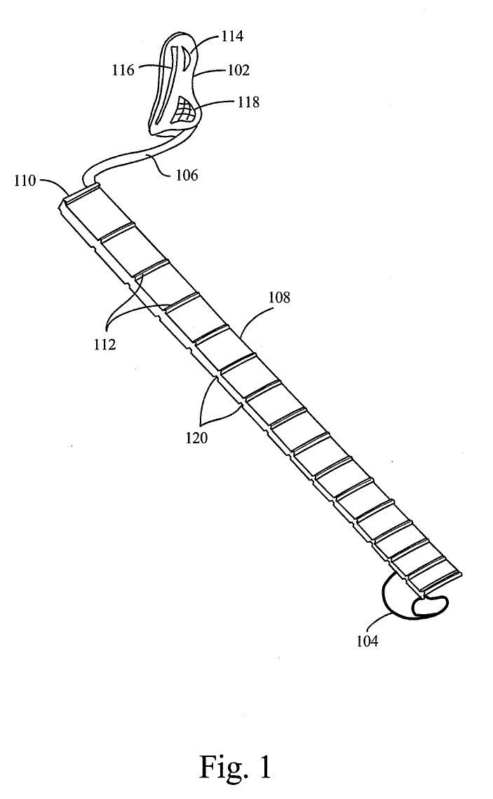

Referring to FIG. 1, an isometric diagram is shown illustrating a learning aid in accordance with one embodiment of the present invention. Shown is a control unit 102, an attachment clasp 104, a communication channel 106, a replacement fret board (or finger board) 108, an overlapping nut 110, a plurality of replacement frets 112, a plurality of fret reliefs 120, input control switches 114, scale keys 116 and mode keys 118. The learning aid in operation will preferably be attached to a stringed instrument (not shown).

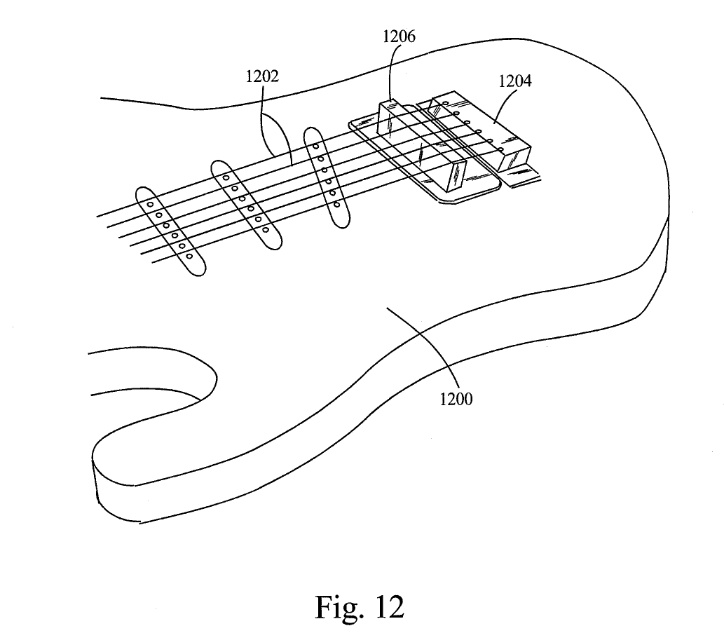

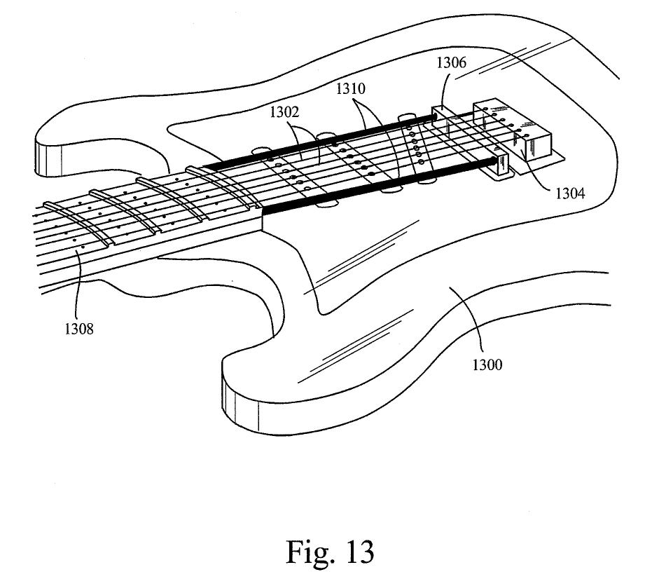

The control unit 102 is electrically coupled to the replacement fret board 108 through the communication channel 106. The replacement fret board 108 is also coupled to the attachment clasp 104. The replacement fret board 108, also referred to herein as a replacement fret board, is shown with a tapered thickness. The end of the replacement fret board 108 nearest the control panel 102 is thicker than the end near the attachment clasp 106. In some of the embodiments described herein, having a tapered replacement fret board 108 will provide the strings of a stringed instrument with clearance of the replacement fret board 108 near the end with the attachment clasp 106. As shown in FIGS. 12 and 13, a replacement bridge optionally is utilized such that the replacement fret board 108 does not need to be tapered and will not interfere with the strings. Alternatively, the fret plate is designed to be thin enough that no tapering is needed. Another alternative is to provide a replacement fret board 108 that has the same width along the entire length, however, have fret reliefs 120 with greater depths near the end of the replacement fret board 108 with the attachment clasp 106. This will keep the replacement fret board 108 from interfering with the strings.

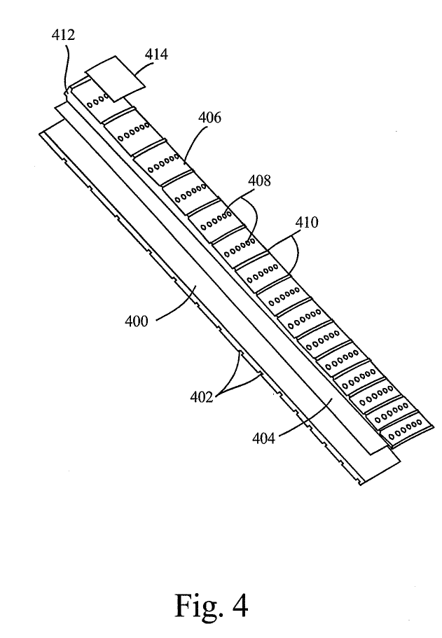

The learning aid of the present invention provides for a device that helps a person learn the correct placement of their fingers on the neck (fretted or non-fretted) of a stringed instrument and optionally aids in the strumming of the instrument. The device preferably has a plurality of indicators (shown, for example, in FIG. 4) that light up and show the user which strings on the instrument to be pressed and also where the strings on the instrument should be pressed. The strings are normally pressed up against the neck of the stringed instrument and then strummed, however, when the learning aid is attached to a stringed instrument, the strings will be pressed against the learning aid.

As is shown, the replacement fret board 108 has a plurality of frets 112, however, the replacement fret board 108 can be made without the frets 112. As is shown in FIG. 4, a plurality of indicators, e.g., light emitting diodes (LEDs), are located along the replacement fret board 108. The LEDs are preferably placed in rows in between the frets 112 of the replacement fret board 108. Alternatively, the LEDs are placed in rows anywhere along the length of the replacement fret board 108 when there are no frets.

Optionally, a row of LEDs is placed at the end of the replacement fret board 108 closest the body of the stringed instrument and indicate to a user which of the strings are to be strummed. In this manner, an LED associated with each string is placed at the end of the replacement fret board 108. The LED associated with each string light up only when that associated string is to be strummed. Alternatively, the LED associated with each string will only light up when a string is not to be strummed.

Generally, the LEDs indicate those strings that are to be played by lighting up, however, the LEDs alternatively indicate strings that are not going to be played by lighting up. In one embodiment, the LEDs are Red/Green LEDs where one of the two colors (e.g., red) will light up, thus indicating that the string is to be played, and the other color (e.g., green) will light up, thus indicating the strings not be played.

Alternatively, the root notes of any given scale or chord are displayed using a different color or brightness in order to give the user a reference point. Therefore, many different color schemes or the LED brightness help a user in learning to play the stringed instrument.

In still another alternative, the LEDs are bi-colored LEDs (e.g., Red/Green LEDs). In order to give the appearance of having more than only two colors available, the control unit 102 alternates very rapidly between the Red and Green color of the LED. Depending upon the length of time each color is on, the LED will give off an appearance of brown or amber. Advantageously, this allows for having more than two colors that can be displayed without having to add additional LEDs to the learning aid. Having more than two colors available for display helps to further distinguish finger placement for a user of the learning aid.

In still another alternative, there are two LEDs for each hole on each of the frets. For example, one green LED and one Red LED. By varying the brightness of the two LEDs (e.g., from off to max power) at least four different colors are achieved. This provides one color for each finger (excluding the thumb) that is used for playing notes such that the correct finger placement is indicated.

Additionally in one embodiment, in order to indicate a string that is not to be strummed, the lights for all of the frets associated with the string that is not to be strummed are lit. Any of the four different colors can be used.

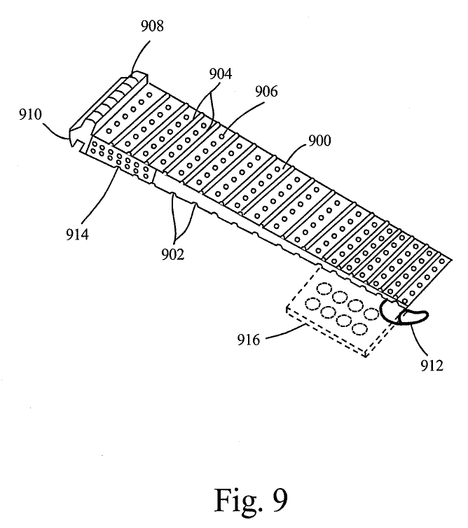

The control unit 102 shown is but one embodiment of a control unit and other types of input switches and control options may be added or removed. Alternative control unit 102 design and placement will be described herein with reference to FIGS. 9-11 and 14-16. The control unit 102 shown attaches to a head of the stringed instrument, however, the control unit 102 is attached to other parts of the stringed instrument or is remote from the stringed instrument in alternative embodiments. When the control unit 102 is remote from the stringed instrument, preferably, the communication channel 106 is a wireless communication channel, however this is not required. The wireless communication channel is used to transmit, for example, a radio wave signal, a laser signal, a frequency modulated signal, a CDMA signal, a TDMA signal, or any other type of communication signal. When the communication channel 106 is a wireless channel, the replacement fret board 108 is equipped with a receiver such that the replacement fret board 108 can received commands from the control unit 102. The commands indicate to the receiver which LEDs that are to light up and what color the LED should light (e.g., Red or Green).

The control unit 102 designed in one embodiment to allow for a chip, card, or memory stick to be inserted allowing new scales, chords, lead riffs, to de displayed. This allows for a user to easily change what is being played and allows for a user to increase the difficulty of what is being played as they progress without having to purchase a new learning aid or new control unit.

In one embodiment, the control unit 102 is implemented utilizing key inputs into a micro controller. The microcontroller controls a serial input LED driver. The serial input LED turns the LEDs on or off. For example, in response to a sequence of key inputs, data is sent from the microcontroller to the LED driver. The LED driver then turns on one or more LEDs. In one embodiment the microcontroller is a programmable interrupt controller (PIC). Optionally, the different variations for chords and scales are stored in charts or table of data. The key inputs then allow a user to select a mode (e.g., chord, scale, single note), select a key (e.g., A, B, C, D), and select a chord type (e.g., major, minor, sharp, flat, sus, dim).

The control unit 102 can be many different types of controlling mechanisms for the LEDs. For example, in different embodiments, the control unit 102 includes a hard wired circuit, a micro-controller, a desktop computer, a personal digital assistant (PDA), a laptop, or many other types of control devices. In one embodiment, a computer with a wireless communication channel can be utilized to control the LEDs. The learning aid can include an antenna for receiving the control signals. Advantageously, this provides for a large amount of flexibility in how the LEDs are controlled as the computer has a lot of processing power. Optionally, new lead riffs or scale patterns are downloaded from a web-site or database. The controller utilizes the lead riffs or scale patterns to change the pattern of when the LEDs light up. Advantageously, this provides a user with the ability to download and learn new material. This amount of processing power is very advantageous for a more advance user. As yet another option, the computer controls the LEDs through a communication port, such as, a universal serial bus (USB). The control of the LEDs is controlled through the use of a software program on the computer. The software program sends control signals over the communication port. The control signals are received at the learning device and utilized to turn on and off the LEDs. For example, the control signals are received at a LED driver that turns the LEDs on and off.

The replacement fret board 108 shown includes the overlapping nut 110, the plurality of replacement frets 112 and the plurality of fret reliefs 120. A more detailed view of one embodiment of the replacement fret board 108 is shown in FIG. 4. The overlapping nut 110 raises the strings of the stringed instrument and eliminates the need to keep the learning aid thin with respect to the frets of the stringed instrument. While, the learning aid can still be made relatively thin, this is no longer a constraint on the design. The learning aid optionally has a set of replacement frets 112 correctly sized relative to the new replacement fret board 108. Preferably, the replacement fret board 108 is thicker at the end having the overlapping nut 110 than at the end coupled to the attachment clasp 104. This prevents the strings of the instrument from contacting any of the plurality of replacement frets 120 on the replacement fret board 108 when the strings are not being pressed by a user and without any height adjustment to a bridge of the stringed instrument. In an alternative embodiment, the replacement fret board 108 is the same thickness throughout, however is thin enough such that the strings of the instrument are prevented from contacting any of the plurality of replacement frets 112 on the replacement fret board 108 without any adjustment to the bridge of the stringed instrument. In yet another embodiment, the bridge of an instrument is modified to accommodate the thickness of the replacement fret board 108 (shown in FIGS. 12 and 13). In other examples, the overlapping nut 110 is not used.

The communication channel 106 comprises, in one embodiment, at least one electrically conductive wire coupling the control unit 102 to the circuit board within the replacement fret board 108. Optionally, the communication channel 106 is a communication bus, a wireless communication channel, a fiber optic channel or any other communication means known or to be developed through which control data for the LEDs is capable of being transferred.

The attachment clasp 104 is attached to the replacement fret board 108. The attachment clasp 104 can be made from a plastic material or a flexible metal. Additionally, alternative materials may be used. The attachment clasp 104 clips over the back of the neck of the stringed instrument and securely holds the replacement fret board 108 in place on the stringed instrument. Alternatively, the attachment clasp 104 is replaced by Velcro straps, elastic bands, or other attachment means. Preferably, the attachment means is designed to keep out of the way of both the front and back of the instrument so as not to interfere with the playing of the instrument. The attachment means optionally extends across the front side of the replacement fret board 108 so long as it does not interfere with the strings or the user's hand placement.

Advantageously, in preferred embodiments, the learning aid provides for a transportable, compact learning aid. Furthermore, the learning aid can be transportable between stringed instruments. The learning aid can also provide for the feel of a real stringed instrument, while providing controlled indicators on the replacement fret board. The learning aid can be used by people of all skill levels.

Optionally, the learning aid also includes a tuner, e.g., a digital tuner, such that the string tone can easily and properly be adjusted after attaching the learning aid to a stringed instrument.

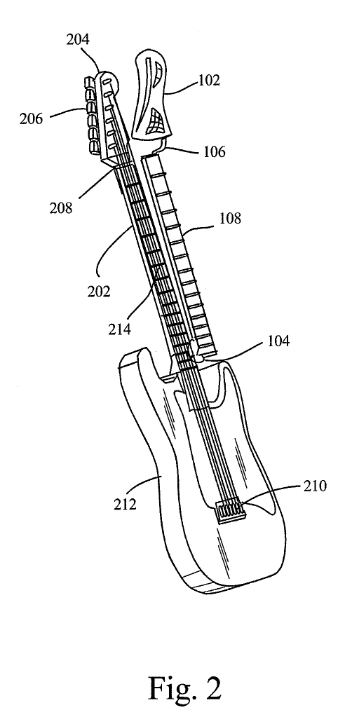

Referring to FIG. 2, an isometric diagram is shown illustrating the learning aid of FIG. 1 detached from a stringed instrument in accordance with an embodiment of the present invention. Shown is a neck of the stringed instrument 202, a head of the stringed instrument 204, a plurality of tuning pegs 206, a nut 208, a bridge 210, a body of the stringed instrument 212, a plurality of strings 214, the control unit 102, the attachment clasp 104, the communication channel 106, and the replacement fret board 108. As is shown, the learning aid is shown detached from the stringed instrument.

The stringed instrument includes the head 204, the neck 202, the nut 208, the body 212, the plurality of tuning pegs 208, the bridge 210, and the plurality of strings 214. The learning aid includes the control unit 102, the communication channel 106, the replacement fret board 108, and the attachment clasp 104.

The stringed instrument includes both fretted and non-fretted instruments, such as, for example, a guitar (electric or acoustic), a banjo, a ukulele, a violin, a viola, and a cello.

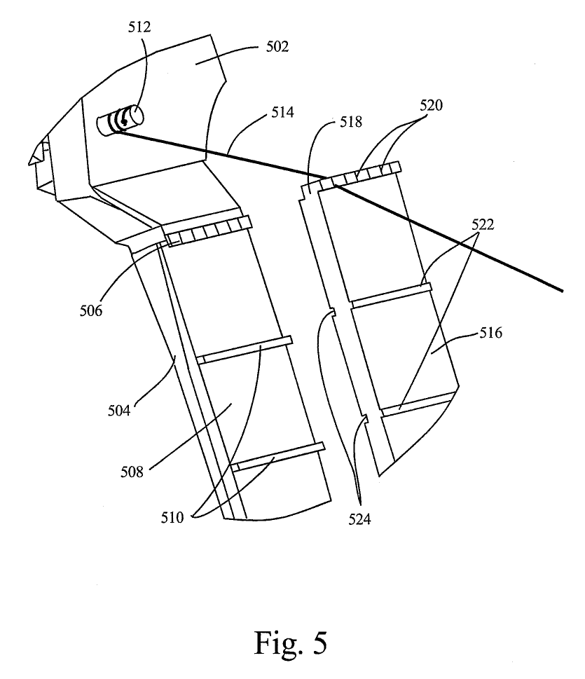

To attach the learning aid to the stringed instrument, first, the plurality of strings are loosened (if they are on the stringed instrument). Next the replacement fret board 108 is placed over the neck 202 of the stringed instrument including the nut 208 of the stringed instrument. The control unit 102 is then coupled to the head of the stringed instrument. In an optional embodiment, the control unit 102 is remote from the replacement fret board 108 or is coupled to the neck 202 or body 212 of the stringed instrument. The plurality of strings 214 are then tightened back down on the overlapping nut 110 (shown in FIGS. 1 and 5) of the replacement fret board 108 and adjusted to be in tune accordingly. Optionally, the learning aid includes a tuner (e.g., a digital tuner) making it easy for a user of the learning aid to re-adjust the string tone after attaching the learning aid.

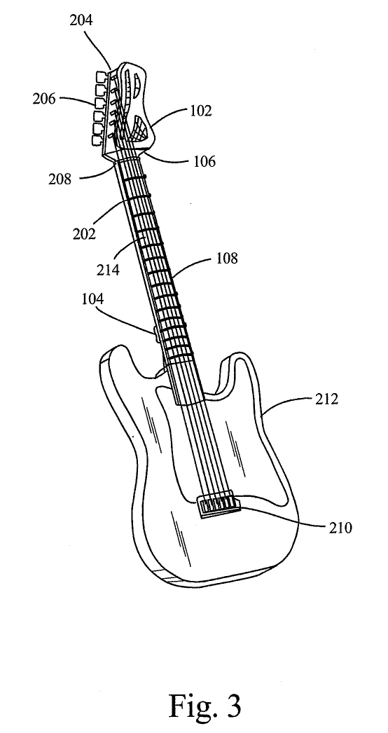

Referring to FIG. 3, an isometric diagram is shown illustrating the learning aid of FIG. 1 attached to the stringed instrument shown in FIG. 2 in accordance with an embodiment of the present invention. Shown is the neck of the stringed instrument 202, the head of the stringed instrument 204, the plurality of tuning pegs 206, the nut 208, the bridge 210, the body of the stringed instrument 212, the plurality of strings 214, the control unit 102, the attachment clasp 104, the communication channel 106, and the replacement fret board 108.

In the embodiment shown, both the control unit 102 and the replacement fret board 108 are detachably coupled to the stringed instrument. The control unit 102 is detachably coupled to the head 204 of the stringed instrument and the replacement fret board 108 is detachably coupled to the neck 202 of the stringed instrument. The replacement fret board 108 is placed in between the plurality of strings 214 and the neck 202 of the stringed instrument such that the replacement fret board 108 is at least partially held in place by the plurality of strings 214. Additionally, the replacement fret board 108 is also optionally held in place by the attachment clasp 104. The learning aid optionally provides for an improved learning tool for beginning users of, for example, a guitar. Additionally, the stringed instrument optionally provides for a learning aid which is used with existing instruments.

Advantageously, a beginning user of a stringed instrument does not have to purchase a specialized instrument with a built in learning aid. Such specialized instruments can be very expensive and thus not marketable to many beginners who do not want to make a large purchase before knowing if they will continue to try and develop their playing skills. In some embodiments, the learning aid is transferable between multiple stringed instruments with little or no adjustment of the learning aid needed.

Referring to FIG. 4, an isometric diagram is shown illustrating a portion of the learning aid of FIG. 1 in accordance with an embodiment of the present invention. Shown is a support plate 400, a plurality of fret reliefs 402 in the support plate, a circuit board 404, a fret plate 406, a plurality of holes 408 in the fret plate, a plurality of replacement frets 410, an overlapping nut 412, and a film covering 414.

The circuit board 404, in one embodiment, is either a Printed Circuit Board (PCB) or Flexible Printed Circuit (herein also referred to as Flex). As referred to herein, the PCB, the Flex and any other type of circuit board are a printed circuit. Preferably the circuit board (i.e., any type of printed circuit), or plurality of printed circuits (as will be described below) will have a plurality of LEDs attached thereto. The LEDs are preferably lined up with the plurality of holes 408 in the fret plate 406. In operation, the lights are controlled by a control circuit 102 (shown in FIGS. 1 and 9-11) and guide a user of the stringed instrument as to which strings should be played. In this manner the LEDs teach a user chords, scales, root note differentiation, on lead riffs. The LEDs indicate either which strings should or should not be pressed along the fret board and alternatively indicate the strings that should or should not be strummed by the person playing the stringed instrument. In other examples, the LEDs can be replaced by a display or displays that present to the user various types of information useful in relation to playing the instrument.

Still alternatively, the LEDs and printed circuit 404 are replaced by a much few number of LEDs or other light source (e.g., between one and five LEDs, preferably one or two LEDs) and a light pipe that reaches the plurality of hole locations (e.g., ninety locations for a 15 fret device). The light pipe is a clear plastic (e.g., polycarbonate or acrylic) piece that optically couples the light source to every hole in the fret board. A looped belt with holes is between the light pipe ends and the fret board. Holes in the belt allow light from the light pipe to pass through the belt and through the holes in the fret board. The light pipe can be a flexible mylar or stainless steel looped belt with a hole pattern in the form of a scale pattern. The belt loop is placed inside of the fret plate of the learning device and can have tractor feed holes along one or two edges. A rotating shaft with an attached gear will mesh with the tractor feed holes allowing the belt to shift position up and down the fret plate. This exposes the appropriate ends of the light pipe under the strings of the different frets located up and down the fret plate. In this manner scales are shown to the user of the learning aid.

The plurality of holes in the fret plate 408 are optionally covered by the film covering 414. The film covering 414 is one covering that covers the entire fret plate 406. Alternatively, the film covering 414 includes a plurality of film pieces that each cover only the holes between two of the replacement frets 410 on the fret plate 406. The film covering protects the holes from debris and also provides for an aesthetic look for the LED light and the fret plate 406. In yet another alternative, the plurality of film pieces each cover more than one set of the plurality of holes 408 in the fret plate 406.

The fret plate 406 includes the plurality of holes 408 and the plurality of replacement frets 410. The plurality of replacement frets 410 are not necessary for stringed instruments that do not have frets on the neck of the stringed instrument. The fret plate 406 can be made any number of different lengths for either the fretted or non-fretted stringed instruments. For example, the fret plate 406 can consist of five to seven frets (or corresponding length for a non-fretted instrument) making it less expensive for a beginning player. Optionally, the fret plate is capable of only showing chords. For the more advance player, the fret plate 406 consists of twelve to fifteen frets and is capable of showing cords, scales, patterns, and lead riffs.

In one embodiment, the bottom of the learning aid, e.g., the support plate 400, has a radius of curvature along the width of the learning aid. Many stringed instruments have a neck (with or without a fret board) that has a curvature along the width. Providing a radius of curvature to match the curvature of the neck of the stringed instrument allows for the learning aid to sit firmly against the stringed instrument and allows for more string clearance on the top of the learning aid. As will be described below, the circuit board 404, a plurality of circuit boards or a plurality of support plates make up the bottom of the learning aid and have a curvature that matches the curvature of the neck of the stringed instrument. In one embodiment, the learning aid can be rigid but flexible in order to conform to the radius of the neck of the stringed instrument. Optionally, the fret plate 406 is attached to the overlapping nut 412 so as to allow the fret plate to flex to conform to the neck of the stringed instrument. For example, the overlapping nut 412 is attached to the plate only at the midpoint or by a swivel.

In another embodiment, the support plate 400 does not include the fret reliefs 402. In this embodiment, the support plate 400 rest on the top of the frets of the stringed instrument. This design can be preferable if it desired to further raise the strings of the stringed instrument away from the fret board of the stringed instrument. The fret reliefs 402 are molded into on single support plate or optionally, the support plate 400 is a plurality of plates slightly spaced apart such that the space in between each of the support plates provides for the fret reliefs 404. Other designs optionally are utilized with a plurality of plates that each have one fret relief or that have a slightly recessed portion at an end that provides a fret relief 404.

Alternatively to having one circuit board 404, the learning aid incorporates a plurality of printed circuits that fit in between each of the frets of the stringed instrument. Advantageously, provides for a thinner design as the support plate 400 is optionally removed and the space in between each of the plurality of circuit boards is used as the fret reliefs 404. In one embodiment, there are 15 individual printed circuits, however, there can be more or less depending upon the desired size of the learning aid and/or the complexity of the learning aid. Additionally, a learning aid for non-fretted stringed instruments employ, in alternative embodiments any number of individual printed circuits. Optionally, the learning aid still includes the support plate (with or without fret reliefs) when utilizing a plurality of printed circuits. For example, each printed circuit has a support plate attached to it and the combination of the support plate and the circuit board provides the fret relief. Again, this provides for a thin design of the learning aid.

In one embodiment, the fret reliefs 404 are created wider than the frets on the stringed instrument. This allows for the learning aid to be transportable to different stringed instruments that have a slightly different spacing between the frets of the stringed instrument. Additionally, the depths of the fret reliefs 404 can be adjusted to provide for more or less relief along the length of the fret plate 406.

Referring to FIG. 5, an isometric diagram is shown illustrating a portion of the learning aid of FIG. 1 in accordance with an embodiment of the present invention. Shown is a head 502 of a stringed instrument, a neck 504 of the stringed instrument, a nut 506, a fret board (or finger board) 508, a plurality of frets 510, a tuning bolt 512, a string 514, a replacement fret board (or fingerboard) 516 of a learning aid, an overlapping nut 518, a plurality of string groves 520, replacement frets 522, and a plurality of fret reliefs 524.

As shown, the replacement fret board 516 is not yet secured in place on the stringed instrument. In order to place the replacement fret board 516 on the stringed instrument, the strings (only one shown) are loosed and the replacement fret board 516 is placed between the replacement fret board 516 of the stringed instrument and the strings 514 of the stringed instrument. The overlapping nut replaces the nut of the stringed instrument and allows the stings 514 to be retuned with the learning aid in place.

The plurality of fret reliefs 524 allow the replacement fret board 516 to fit securely on the fret board 508 of the stringed instrument without elevating the replacement fret board 516. In some embodiments, the fret reliefs 524 are not desirable or needed and the bottom of the replacement fret board 516 is flat.

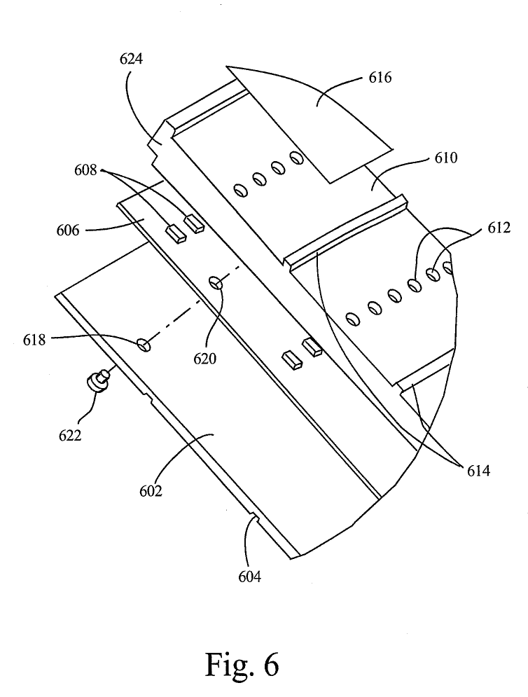

Referring to FIG. 6, an isometric diagram is shown illustrating an exploded portion of the learning aid of FIG. 1 in accordance with an embodiment of the present invention. Shown is a support plate 602, a plurality of fret reliefs 604 in the support plate, a circuit board 606, a plurality of indicators 608, a fret plate 610, a plurality of holes 612 in the fret plate, a plurality of replacement frets 614, a film covering 616, a hole in the support plate 618, a hole in the circuit board 620, a screw 622 and an overlapping nut 624.

The diagram shows various parts of the learning aid separated so as to provide a more detailed view in accordance with one embodiment. The circuit board 606 and support plate 602 are attached to the fret plate 610 with a screw 622 that is placed through both the hole in the support plate 602 and the hole in the circuit board 606. This is but one means for fastening the support plate 602 and the circuit board 606 to the fret plate 610 and other fastening means are utilized in different embodiments. For example, the support plate 602 and the circuit board 606 can be fastened to the fret plate 610 with an adhesive.

The plurality of indicators 608, e.g., LEDs, line up with the plurality of holes 612 in the fret plate 610. Thus, when one or more of the indicators 608 is turned on, the light from the indicator 608 will pass up through the hole 612 and through the film covering 616. This indicates to a user of the learning aid which strings are to be played on the stringed instrument.

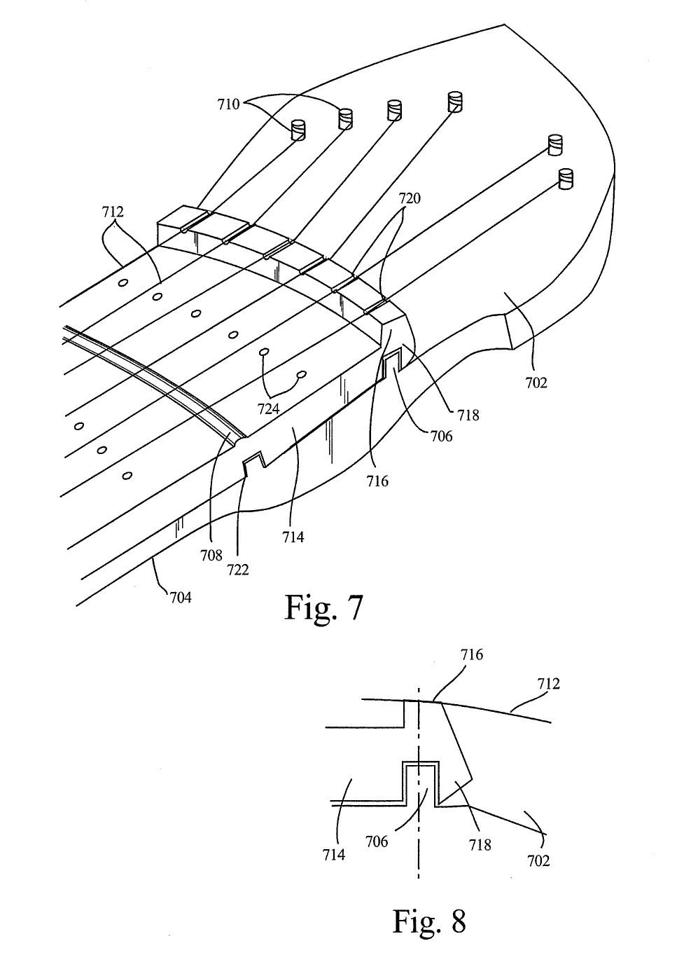

Referring to FIG. 7 an isometric diagram is shown illustrating a portion of a learning aid in accordance with another embodiment of the present invention. Shown is a head 702 of a stringed instrument, a neck 704 of the stringed instrument, a nut 706, a fret 708, a plurality of tuning bolts 710, a plurality of strings 712, a replacement fret board (or finger board) 714 of the learning aid, an overlapping nut 716, a hook 718, a plurality of string groves 720, a fret relief 722, a replacement fret 724 and a plurality of holes.

Referring to FIG. 8 a side cross sectional view is shown illustrating a portion of the learning aid of FIG. 7 in accordance with an embodiment of the present invention. Shown is the head 702 of the stringed instrument, the nut 706, the string 712, the fret plate 714, the overlapping nut 716, and the hook 718.

The learning aid is similar to any of the learning aids described herein, however, the hook 718 is attached to the overlapping nut 716 or molded as part of the overlapping nut 716. In some embodiments described herein, the learning aid has a tendency to move toward the body of the stringed instrument because of the force put on the overlapping nut 716 by the plurality of strings 712. The hook 718 contacts the side of the nut 706 closest the head 702 of the stringed instrument and counteracts the force of the strings 712 on the overlapping nut 716, causing the learning aid to remain in place.

The hook 718 can be either attached to the overlapping nut 716 or be molded as part of the overlapping nut 716. The hook 718 can be many different shapes or sizes and should be strong enough to counteract any force placed on the overlapping nut 716 by the strings 712 without breaking.

Referring to FIG. 9 an isometric diagram is shown illustrating a learning aid in accordance with an alternative embodiment of the present invention. Show is a replacement fret board (or finger board) 900, a plurality of fret reliefs 902, a plurality of replacement frets 904, a plurality of indicators 906, an overlapping nut 908, a hook 910, an attachment clasp 912, a control panel 914 in a side of the replacement fret board 900, and an alternative control panel 916 located proximate to an attachment clasp 912.

Advantageously, the control panel 914 in the side of the replacement fret board 900 or the alternative control panel 916 does not get in the way of a user of the device. Additionally, either position of the control panel will provide easy access in order to change what is being displayed by the plurality of indicators 906, for example, scales, chords, or lead riffs.

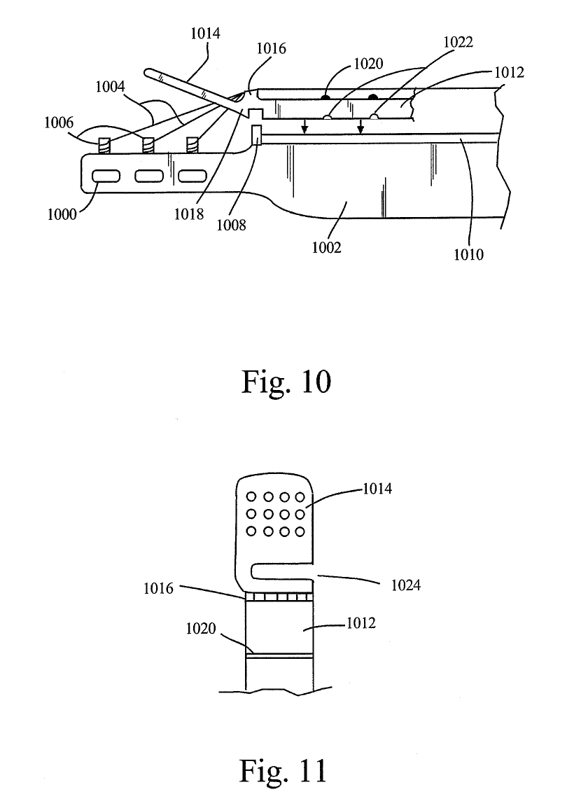

Referring to FIG. 10 an isometric diagram is shown illustrating a learning aid in accordance with one yet another alternative embodiment of the present invention. Shown is a head 1000, a neck 1002, a plurality of strings 1004, a plurality of adjustment screws 1006, a nut 1008, a fret board (or finger board) 1010, a replacement fret board (or finger board) 1012, a control panel 1014, a overlapping nut 1016, a hook 1018, a plurality of replacement frets 1020, and a plurality of fret reliefs 1022.

Referring to FIG. 11 a top cross sectional view is shown illustrating of a portion of the learning aid of FIG. 10 in accordance with an embodiment of the present invention. Shown is the replacement fret board 1012, one of the plurality of replacement frets 1020, the overlapping nut 1016, an opening for strings to pass through 1024, and the control panel 1014.

The replacement fret board 1012 and overlapping nut 1016 are similar to the embodiments described herein. The learning aid, however, includes the control panel 1014 located near the head 1000 of the stringed instrument. This conveniently allows for an easily accessible control panel while keeping the control panel 1014 from interfering with playing the stringed instrument. The opening 1024 is cut away such that the strings 1004 can pass through it without touching part of the control panel 1014, thus, not interfering with the operation of the stringed instrument. As described above, the control panel 1014 can include a replaceable chip or flash card in order to change the operation of the learning aid.

Advantageously, FIGS. 9-11 demonstrate a few of the many different options for the control panel in accordance with the present invention.

Referring to FIG. 12 is an isometric diagram is shown illustrating a replacement bridge in accordance with an embodiment of the present invention. Shown is a body 1200 of a stringed instrument, a plurality of strings 1202, a bridge 1204 of the stringed instrument, and a replacement bridge 1206.

Advantageously, the replacement bridge 1026 provides for a means to lift the strings 1202 away from the body of the stringed instrument similar to the overlapping nut of the learning aid. The replacement bridge 1026 is held in place by the force of the strings and a friction pad where the replacement bridge 1026 contacts the guitar body.

In one embodiment, the fret plate of the learning aid does not have a tapered width (thick to thin, starting from the head down to the body) as the replacement bridge 1206 will lift the strings 1202 at the opposite end of the overlapping nut, thus keeping the strings from interfering with the fret plate.

Referring to FIG. 13 an isometric diagram is shown illustrating another replacement bridge in accordance with an alternative embodiment of the present invention. Shown is a body 1300 of a stringed instrument, a plurality of strings 1302, a bridge of the stringed instrument 1304, a replacement bridge 1306, a replacement fret board (or finger board) 1308 and a plurality of rods 1310.

The replacement fret board 1308 is attached to the plurality of rods 1310 at the end opposite of the overlapping nut (not shown). The plurality of rods 1310 are also attached to the replacement bridge 1306.

The rods 1310 provide a coupling between the replacement fret board 1308 and the replacement bridge 1306. As discussed above with reference to FIG. 7, the strings place a force on the overlapping nut that will force the replacement fret board 1308 toward the body of the stringed instrument. Because the replacement bridge 1306 is coupled to the replacement fret board 1308 through the plurality of rods 1310, the forces will cancel each other out and the replacement fret board will stay in place without then need for a hook on the overlapping nut. In this embodiment, the string force will hold the replacement bridge 1306 in place. The rods 1310 also set the correct scale distance between the replacement nut and the replacement bridge.

The rods 1310 can optionally be retractable or extendable rods or strips that allow accurate fret and scale spacing to the replacement bridge.

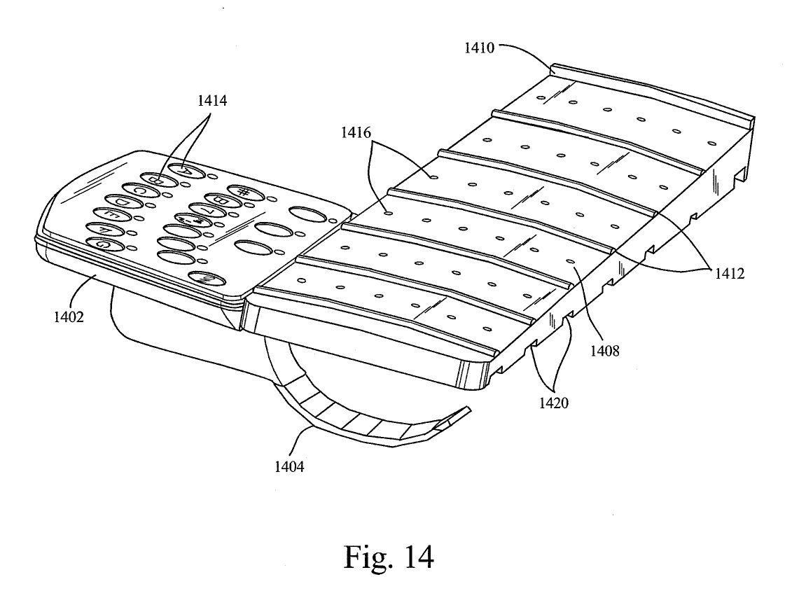

Referring to FIG. 14 an isometric diagram is shown illustrating slightly elevated view of a learning aid in accordance with another embodiment. Shown is a control unit 1402, an attachment clasp 1404, a replacement fret board (or finger board) 1408, an overlapping nut 1410, a plurality of replacement frets 1412, a plurality of fret reliefs 1420, a plurality of input buttons 1414 and a plurality of holes 1416 in the replacement fret board.

The control unit 1402 is coupled to the attachment clasp 1404 and the replacement fret board 1408. The position of the control unit 1402 is such that it will not greatly interfere with a user playing a musical instrument while using the learning aid. The control unit 1402 includes the plurality of input buttons 1414. The plurality of input button 1414 includes note buttons, key buttons and mode buttons. The attachment clasp 1404 secures the learning aid to a stringed instrument (not shown). As described above, the learning aid also is held in place by the tension of the strings of the stringed instrument. In the present embodiment the plurality of fret reliefs 1420 are wider than those shown and described above with reference to FIGS. 1-8. This allows for the learning aid to be used with a variety of different stringed instruments while accommodating shifting of the learning aid to different scales.

The learning aid shown in FIG. 14 includes six frets. Alternative embodiments include more or less frets. More frets are preferably used by more advanced players, while the six fret learning aid is used by more beginner players.

The control unit 1402 is electrically coupled to a plurality of indicators (not shown). As described above, the plurality of indicators are preferably LEDs. The LEDs are located beneath the plurality of holes 1416. The control unit 1402 selectively turns the LEDs on and off, indicating which strings are to be depressed by the user. In this manner, the user learns to play different songs, chords and scales. More generally, the user learns to play the stringed instrument.

In one embodiment, the control unit stores information relating to one or more songs. The information controls which strings are to be depressed by the user, thus, enabling the user to replicate the song on the stringed instrument.

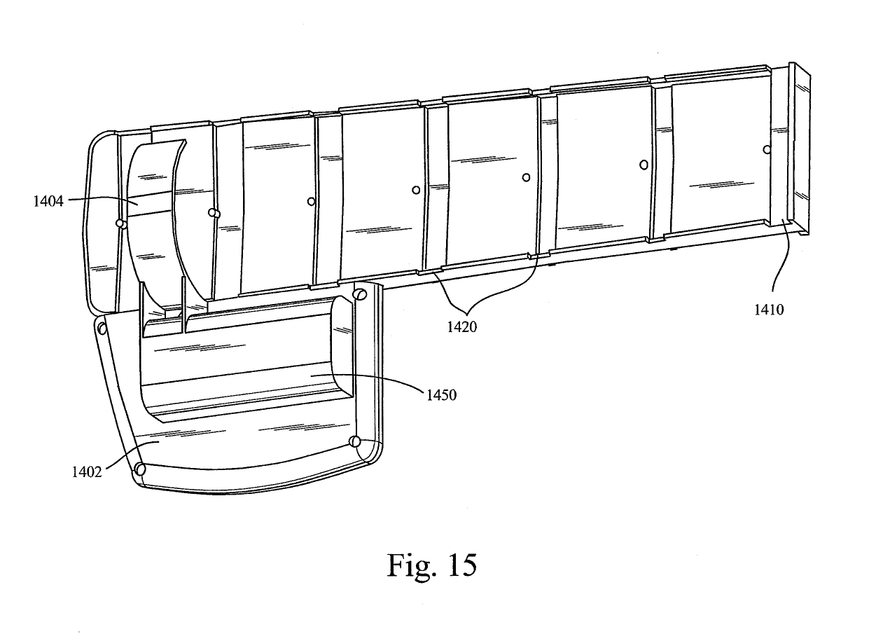

Referring to FIG. 15 an isometric diagram is shown illustrating a bottom view of the learning aid of FIG. 14. Shown is the control unit 1402, the attachment clasp 1404, the overlapping nut 1410, the plurality of fret reliefs 1420, and a battery package 1450. The battery package 1450 holds two AA batteries in one embodiment. The batteries provide power for the control unit 1402 and the plurality of indicators (not shown). Alternatively, the control unit 1402 and the plurality of indicators are powered through power from an AC outlet, utilizing a AC to DC converter. Still alternatively, the learning aid can be powered primarily from an AC outlet while utilizing the batteries as backup power.

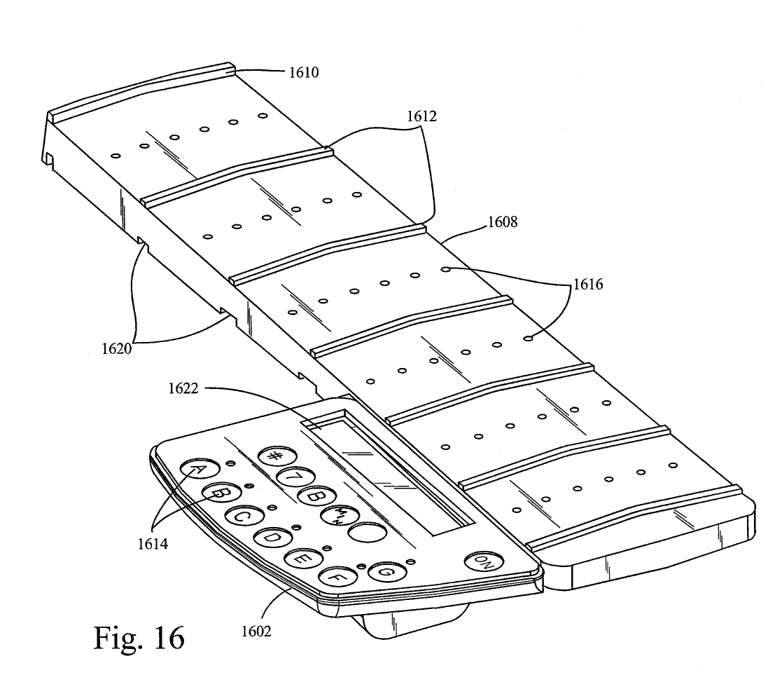

Referring to FIG. 16 an isometric diagram is shown illustrating an alternative embodiment of a learning aid according to one embodiment. Shown is a control unit 1602, a replacement fret board (or finger board) 1608, an overlapping nut 1610, a plurality of replacement frets 1612, a plurality of fret reliefs 1620, a plurality of input buttons 1614, a display screen 1622 and a plurality of holes 1616 in the replacement fret board.

The embodiment shown is similar to the embodiment described above with reference to FIG. 14, however, the display screen 1622 has been added to the control unit 1602. The display screen 1622 is in one embodiment a liquid crystal display (LCD) screen. Alternative types of display screen are also optionally used. The display screen 1622 is utilized to display, for example, the song, scale or chord that is being output to a plurality of indicators. For example, if the plurality of indicators are displaying the strings to be depressed to play a scale in A minor, the display screen will read “A minor.”

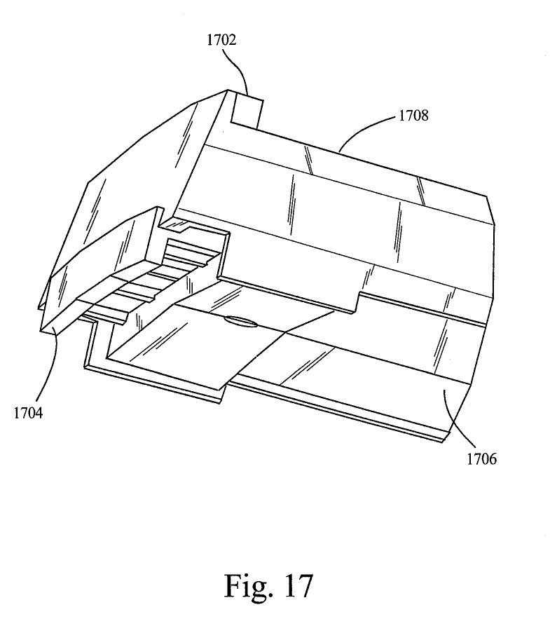

Referring to FIG. 17 an isometric diagram is shown illustrating a slightly lowered view of a portion of a learning aid in accordance with an alternative embodiment. Shown is a replacement nut 1702, an overlapping nut slider 1704, a support board 1706 and a fret plate 1708.

The overlapping nut slider 1704 is movably coupled to the fret plate 1708 and the support board 1706. The overlapping nut slider 1704 adjusts such that the learning aid can be used with many different stringed instruments as long as the stringed instrument has the same or longer scale than the learning aid. The overlapping nut slider 1704 (also referred to herein as the slider 1704) allows the learning aid to be placed on different sized scales (e.g., 24.75″, 25.5″) while being able to stay in tune from one note to the next. The overlapping nut slider 1704 adjusts and determines how the fret plate sits on the stringed instrument in relation to the nut of the stringed instrument. The slider 1704 is one example of an adjustment device for adjusting the distance between the replacement nut 1702 and a bridge of a stringed instrument such that a proper tune of the instrument is maintained while using the learning aid. Other adjustment devices and means for adjusting the distance between the replacement nut 1702 are utilized in alternative embodiments.

In one embodiment, graphics are provided on a top of the slider 1704 can indicate to the user how far it must be extended for the particular instrument the learning aid is being used with. Alternatively, an adjustable thumbscrew can be used to set the proper distance from the existing nut. Still alternatively, an oblong lever or a separate measuring device (e.g., a wire, a paper measuring unit, a rule) can set the proper distance.

The slider 1704 places the fret plate the correct distance from the bridge of a stringed instrument such that the instrument is in proper tune.

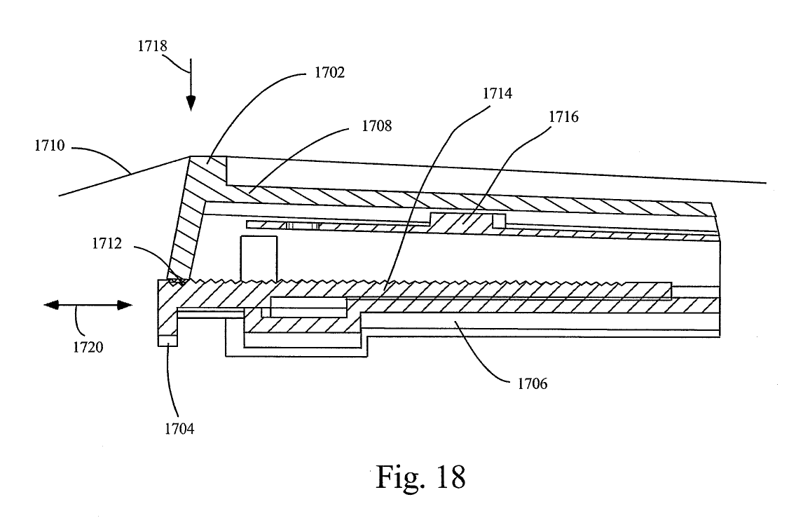

Referring to FIG. 18 is a side cross sectional view of the learning aid of FIG. 17. Shown is the replacement nut 1702, the overlapping nut slider 1704, the support board 1706, the fret plate 1708, a string 1710, fret plate teeth 1712, nut slider teeth 1714, a circuit board 1716, a string force direction arrow 1718, and a slider movement of direction arrow 1720.

The overlapping nut slider 1704 moves in and out of the learning aid in the as indicated by the slider movement of direction arrow 1720. The overlapping nut slider 1704 provides one exemplary means for adjusting the distance from the replacement nut 1702 and a bridge of a stringed instrument. When the learning aid is place on the stringed instrument, the overlapping nut slider can be adjusted to the proper distance (such as described above with reference to FIG. 17. The strings of the stringed instrument are then tightened, thus exerting a force which is indicated by the string force direction arrow 1718. The force causes the fret plate teeth 1712 to engage the nut slider teeth 1714, thus preventing the overlapping nut slider 1704 from moving while the learning aid is in use.

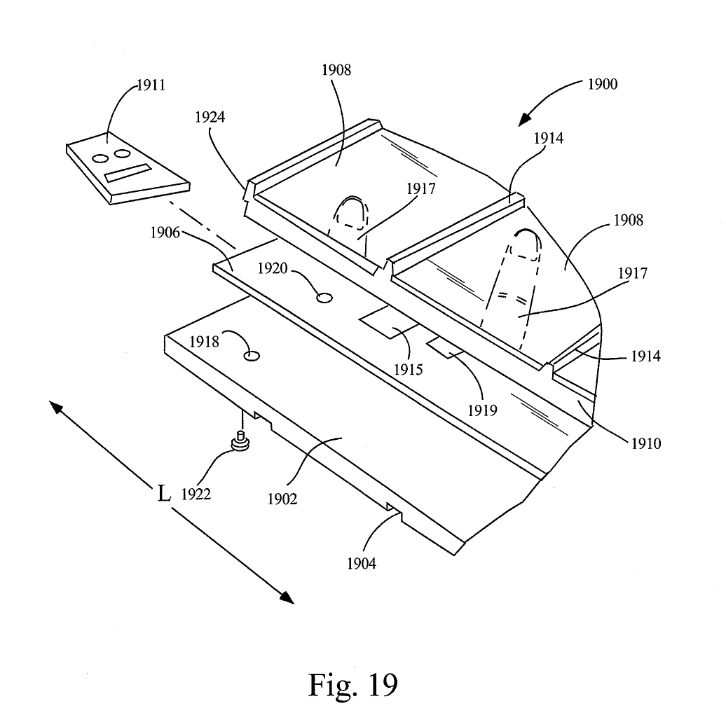

Referring now to FIG. 19, an isometric diagram of another example of a learning aid 1900 is described. Shown is a support plate 1902, a plurality of fret reliefs 1904 in the support plate 1902, a circuit board 1906, a display 1908 that is attached to or otherwise incorporated into a plate 1910, a plurality of replacement frets 1914, a hole in the support plate 1918, a hole in the circuit board 1920, a screw 1922 and an overlapping nut 1924. In an alternative example, a non-overlapping nut may be used. In still other examples, no replacement nut is used. Further, a replacement bridge can be used as has been described elsewhere herein. In other examples, no replacement bridge is used.

The thickness of the learning aid 1900 may vary lengthwise along a length L of the learning aid 1900. In alternative examples, the thickness may remain substantially the same along the length L. To take one example, the thickness may be varied by varying the thickness of the plate 1910. The overall thickness of the learning aid may be varied by varying the thickness of any of the other components (or combination of components) as well.

It will be appreciated that the display 1908 can be used in any of the other examples described herein, for instance, to replace LEDs. In other examples, the display 1908 may supplement the function of the LEDs.

The circuit board 1906 and support plate 1902 are attached to the plate 1910 with a screw 1922 that is placed through both the hole in the support plate 1902 and the hole in the circuit board 1906. It will be understood that this is one example for fastening the support plate 1902 and the circuit board 1906 to the plate 1910 and other fastening approaches are possible. For example, the support plate 1902 and the circuit board 1906 can be fastened to the plate 1910 with an adhesive.

The display 1908 can be any type of display using any type of display technology for displaying video images. These images may move over time and can vary in speed moving faster at some times than others. For example, the display 1908 can be liquid crystal displays (LCD), a plasma display, or a touch screen display. Other examples of displays are possible.

The display 1908 can be configured as a single display segment or include multiple segments. If a single segment is used, this single segment may extend along the entire or substantially the entire length of the learning aid. If a multiple segments are used, some of the segments may be used to display some types of information and other segments may be used to display other types of information. The use of multiple segments and the placement of these segments may allow all of these segments to be observed by the user (i.e., not covered or obstructed by other parts of the stringed instrument).

The display 1908 can be used to display any type of information and present the information visually in any way. As shown in FIG. 19, and to describe only one example, images 1917 of fingers are displayed to indicate where a user should place their fingers to play the instrument. In this regard, it will be understood that strings may extend over the display 1908 and the fingers of the user will contact the strings as the user attempts to match their finger position with the images. In other examples, other types of information such as other images, alphanumeric text, or shapes may be presented on the display 1908. The color, intensity, or any other visual characteristic of these images may also be adjusted. In other examples, audio information may also be presented to the user in combination with the information presented on the display 1908. The sizes of the images 1908 can also vary. In one example, the images can be life size finger images while in other examples the images can be larger or smaller than real fingers.

Further, the images or other information presented on the display may change over time. For example, the images 1917 move over time as the system indicates where the user should place their fingers as a song progresses.

As shown in FIG. 19, the display 1908 is incorporated into a learning aid which is disposed on to or attached to an existing string instrument. In an alternative example, the display 1908 can be embedded in an existing neck or otherwise directly incorporated into an existing instrument.

A controller 1915 on the circuit board 1906 is used to control the operation of the display 1908. The controller 1915 may be coupled to an associated memory 1919 that is used to store operating information for the display 1908 (e.g., data indicating images of a finger or fingers, or a hand, and how the placement of the fingers changes as chords, scales, or a song progresses).

The controller 1915 is also coupled to a user interface 1911. The user interface 1911 may be used to program or otherwise control the display 1908. In some examples, the interface 1911 can be used to upload information into the processor 1915. The interface 1911 may include a wide variety of controls (e.g., buttons, switches, or touch screen to name a few examples) that allow the user to control and/or program the operation of the display 1908. A wide variety of different types of connections can be used between the interface 1911 and the controller 1915. For example, the connections can be wired or wireless. Other examples of connections are possible. In addition, the interface 1911 may be coupled to other external sources such as the Internet, a cellular phone network, to name a few examples.

So configured, the learning aid of FIG. 19 can be used to visually indicate to a user where to place their hands and/or fingers to effectively play an instrument by displaying images on the display (e.g., images of fingers). Other information useful in playing or learning to play the instrument may also be presented to the user via the display 1908.

The display 1908 may also provide feedback to the user. In this case, the display 1908 may be a touch screen and, to take one example, the display 1908 (and controller 1915) may sense if the user has placed their finger in the indicated position. If the user has failed to place their finger in the correct position, this incorrect placement may be sensed and the processor may issued an appropriate annunciation (e.g., using the display 1908 or some other approach such as an audio speaker) to inform the user. The processor 1915 may also use obtained information to rate (or otherwise analyze) the performance of a user and/or indicate areas of improvement for the user. Alternatively, the information may be uploaded to another system (e.g., via the interface 1911) for further processing, analysis and/or display.

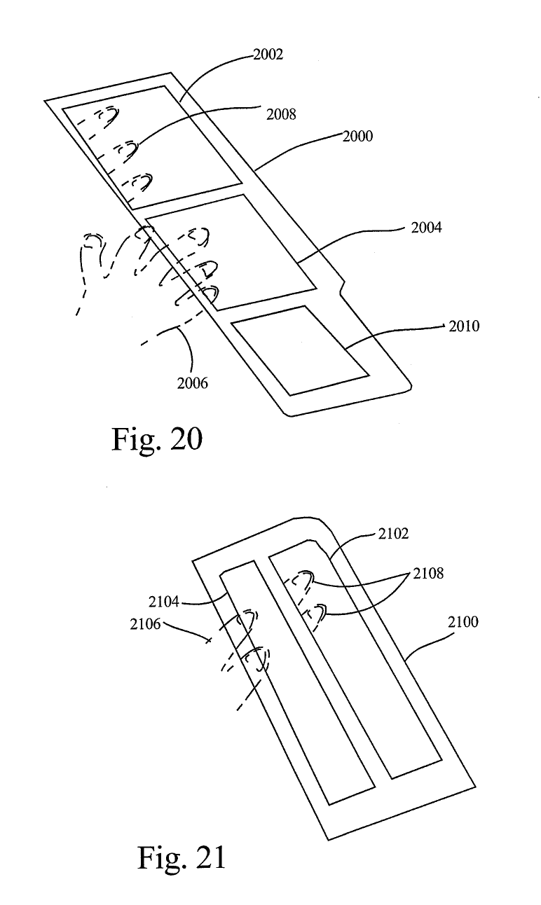

Referring now to FIG. 20, a stringed instrument using multiple displays is described. As shown, a stringed instrument 2000 includes a first video display 2002 and a second video display 2004. The first and second video displays 2002 and 2004 are vertically adjacent to each other. The hand and fingers 2006 of a user are placed to play strings (not shown) of the instrument 2000. The video display 2002 presents images 2008 of fingers and/or a hand to show the correct placement of the fingers of the user. The display 2004 does not display images. In one example, the display 2002 is unobstructed by portions of the instrument and/or the user while in another example obstructions (either from the instrument or user) may be present.

If frets are used, the displays may be between frets, over frets, or the frets themselves may be on the top of some or all of the displays. In other words, the dimensions of the displays may vary according to the needs of the user, system, or application.

In another example, the user may move their hands downward over a third display 2010, the display 2002 is deactivated, the display 2004 is activated, and the images are presented on the display 2004. Hence, the user can move their hand around the instrument and the images can follow hand movement so as to instruct the user as to correct hand and/or finger placement.

Referring now to FIG. 21, another example of a stringed instrument using multiple displays is described. As shown, a stringed instrument 2100 includes a first video display 2102 and a second video display 2104. The first and second video displays 2102 and 2104 are horizontally adjacent to each other. The hand and fingers 2106 of a user are placed to play strings (not shown) of the instrument 2100. The video display 2102 presents images 2108 of fingers and/or a hand to show the correct placement of the fingers of the user. The display 2104 does not display images. In one example, the display 2102 is unobstructed by portions of the instrument and/or the user while in another example obstructions (either from the instrument or user) may be present.

As with the example of FIG. 20, further displays can be used with the instrument 2100. Hence, the user can move their hand around the instrument and the images can follow the hand movement of the user so as to instruct the user as to correct finger and/or hand placement.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

What I claim is:

1. An apparatus for a stringed instrument comprising:
a replacement finger board for non-intrusive placement over an existing finger board comprising:
a plate having a top end and a bottom end, the plate having a varying thickness along the longitudinal length of a main axis connecting the top end and the bottom end, the thickness decreasing lengthwise from a first thickness at the first end of the plate to a second thickness at a second end of the plate;
an attachment member coupled to the replacement finger board for securing the finger board to the stringed instrument.

2. The apparatus of claim 1 further comprising a support board, the support board including fret relief notches and being coupled to the plate, the fret relief notches configured and arranged to fit over existing frets of the instrument.

3. The apparatus of claim 1 further comprising an integral replacement nut disposed so as to be non-overlapping with an existing nut.

4. The apparatus of claim 1 further comprising a replacement bridge coupled to a bridge of the stringed instrument.

5. The apparatus of claim 4 further comprises means for coupling the replacement bridge to the replacement finger board.

6. An apparatus of claim 1 further comprising a circuit board coupled to the plate.

7. The apparatus of claim 1 wherein the plate includes a plurality of replacement frets.

8. The apparatus of claim 7 wherein the plate includes a plurality of lights in between the plurality of replacement frets.

9. The apparatus of claim 1 further comprising an overlapping nut slider for measuring where to position the finger board.

10. A learning apparatus for a stringed instrument comprising:
a replacement finger board arranged to non-intrusively rest between an existing finger board and a plurality of strings of the stringed instrument, the finger board having a top end and a bottom end and having a varying thickness along the longitudinal length of a main axis connecting the top end and the bottom end, the thickness decreasing lengthwise from a first thickness at the first end of the finger board to a second thickness at the second end of the finger board;
a controller configured to control an indicator coupled to the replacement finger board;
wherein the indicator displays information indicating finger placement of fingers of a user.

11. The apparatus of claim 10 further comprising an attachment member coupled to the replacement finger board for securing the plate to the stringed instrument.

12. The apparatus of claim 10 wherein a bottom of the replacement finger board includes a plurality of fret reliefs.

13. The apparatus of claim 10 wherein a top of the replacement finger board includes a plurality of replacement frets.

14. A learning apparatus for a stringed instrument comprising:
a replacement finger board arranged to non-intrusively rest between an existing finger board and a plurality of strings of the stringed instrument;
a controller configured to control a display integral with the replacement finger board;
wherein the display presents information indicating finger placement of fingers of a user.

15. The learning apparatus of claim 14 wherein the finger board has a top end and a bottom end and has a varying thickness along the longitudinal length of a main axis connecting the top end and the bottom end, the thickness decreasing lengthwise from a first thickness at the first end of the finger board to a second thickness at the second end of the finger board.

16. The learning apparatus of claim 14 wherein the display is selected from a group consisting of: a liquid crystal display, a plasma display, a display utilizing at least one light emitting diode, and a touch screen display.

17. The learning apparatus of claim 14 wherein the information comprises an image of a finger.

18. The learning apparatus of claim 14 further comprising an integral replacement nut.

19. The learning apparatus of claim 14 further comprising a replacement bridge coupled to a bridge of the stringed instrument.

20. The learning apparatus of claim 19 further comprises means for coupling the replacement bridge to the replacement finger board.
